(19) United States
(12) Patent Application Publication
(10) Pub. No.: US 2005/0269044 A1
(43) Pub. Date: Dec. 8, 2005

(54) Shutter blade structure

(76) Inventor: Leslie Nien, Changhua Hsien (TW)

Correspondence Address: TROXELL LAW OFFICE PLLC, SUITE 1404, 5205 LEESBURG PIKE, FALLS CHURCH, VA, 22041, US

(21) Appl. No.: 10/920,261

(22) Filed: Aug. 18, 2004

(30) Foreign Application Priority Data
Jun. 3, 2004 (TW) 093208778

(51) Int. Cl. E06B 9/08

(52) U.S. Cl. 160/236

(57) ABSTRACT

A shutter blade structure includes a shutter integrally made into a transparent, semi-transparent, or opaque hollow shape with solid, colored, or patterned decoration designs disposed at the surface thereon. The shutter thereof has an oval-shaped hollow sleeve chamber disposed at the interior therein for two support rods to be oppositely located therein, and a support opening respectively formed at both ends thereof for a retaining cap to be registered therewith so as to neatly expand the full width of the hollow sleeve chamber thereby. The retaining cap is provided with a pair of positioning holes symmetrically disposed at one side thereon for holding in place both ends of the two support rods respectively, precisely stretching out the full length of the shutter thereof. Besides, the retaining cap is also equipped with a coupling section properly protruding at the other side thereon to be mounted to a left/right side frame of a ventilation window, or reversibly located at the hollow sleeve chamber therein for use on a Venetian blind. Thus, the shutter is flexibly fit to both ventilation windows and Venetian blinds, and is capable of being produced on a massive scale, efficiently simplifying the steps of processing so as to reduce the cost of production for achieving the economical efficiency and boosting the competitive power thereof on the market.

### BACKGROUND OF THE INVENTION

The present invention is related to a shutter blade structure, including a shutter integrally made into a transparent, semi-transparent, or opaque hollow shape with solid, colored, or patterned decoration designs disposed at the surface thereon. The shutter thereof has an oval-shaped hollow sleeve chamber disposed at the interior thereof for two support rods to be oppositely located therein, and a support opening respectively formed at both ends thereof for a retaining cap to be registered therewith so as to neatly expand the full width and length of the shutter in three-dimensional configuration. Besides, via coupling sections of the retaining caps to be mounted to side frames of a ventilation window or reversibly located at the hollow sleeve chamber therein, the shutter is flexibly fit to both ventilation windows and Venetian blinds, and is capable of being produced on a massive scale, efficiently simplifying the steps of processing so as to reduce the cost of production for achieving the economical efficiency and boosting the competitive power thereof on the market.

Please refer to FIGS. 1 to 2 inclusive. A conventional shutter 10 for ventilation windows as shown in FIG. 10 and a shutter 20 for Venetian blinds as shown in FIG. 2 must be individually made into a standardized size and molded into a certain length for different purposes thereof, which, complicated in the process thereof, makes them rather difficult to be produced on a massive scale. Thus, the conventional shutters 10, 20 are uneconoinically high in the cost of production and uncompetitive on the market.

### SUMMARY OF THE PRESENT INVENTION

It is, therefore, the primary purpose of the present invention to provide a shutter blade structure, including a shutter having an oval-shaped hollow sleeve chamber disposed at the interior therein for two support rods to be oppositely located therein, and a support opening respectively formed at both ends thereof for a retaining cap to be registered therewith so as to neatly expand the full width and length of the shutter in three-dimensional configuration with decoration designs disposed thereon. Besides, via coupling sections of the retaining caps to be mounted to side frames of a ventilation window or reversibly located at the hollow sleeve chamber therein, the shutter is flexibly fit to both ventilation windows and Venetian blinds, and is capable of being produced on a massive scale, efficiently simplifying the steps of processing so as to reduce the cost of production for achieving the economical efficiency and boosting the competitive power thereof on the market.

### BRIEF DESCRIPTION OF THE DRAWINGS

FIG. 1 is a perspective view of a conventional shutter for ventilation windows.

FIG. 2 is a perspective view of a conventional shutter for Venetian blinds.

FIG. 3 is a perspective exploded view of the present invention.

FIG. 4 is a diagram showing the present invention mounted onto a ventilation window in assembly.

FIG. 5 is a diagram showing the present invention mounted onto a Venetian blind in assembly.

FIG. 6 is a perspective view of another embodiment of the present invention.

FIG. 7 is a perspective view of a third embodiment of the present invention.

FIG. 8 is a diagram showing the third embodiment of the present invention in a complete sheltering status.

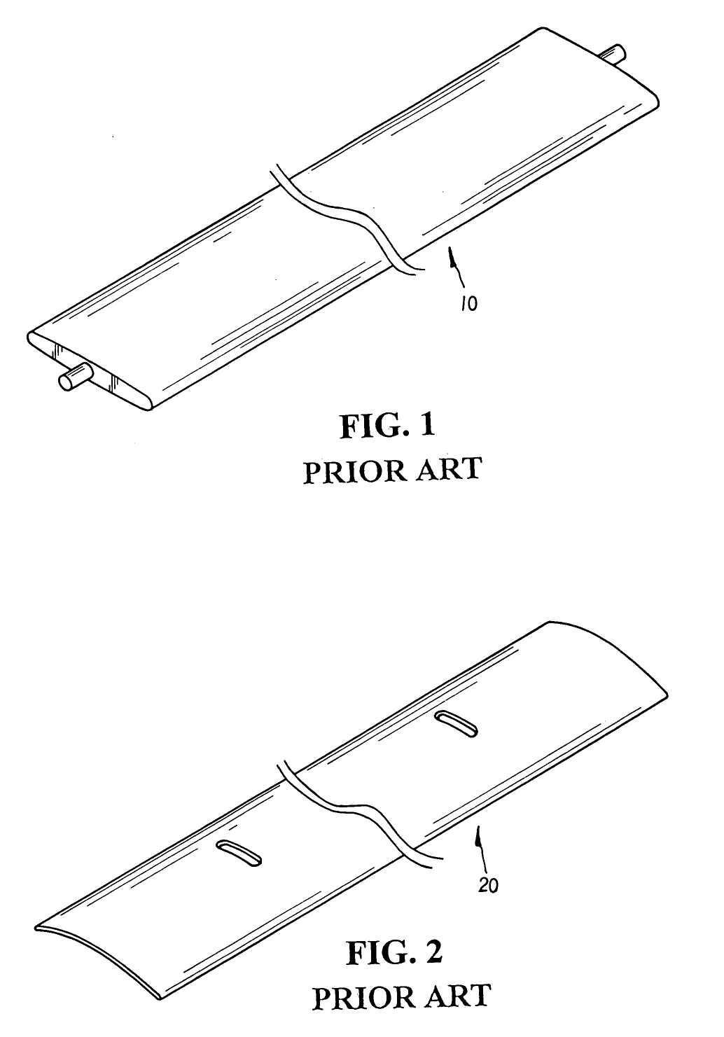

### DETAILED DESCRIPTION OF THE PREFERRED EMBODIMENTS

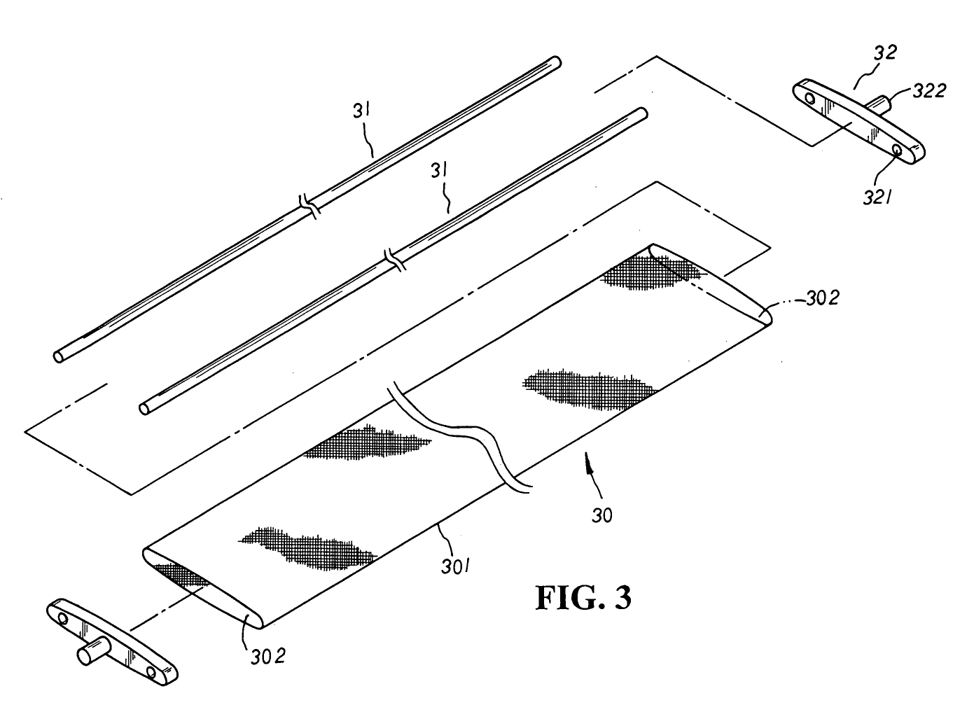

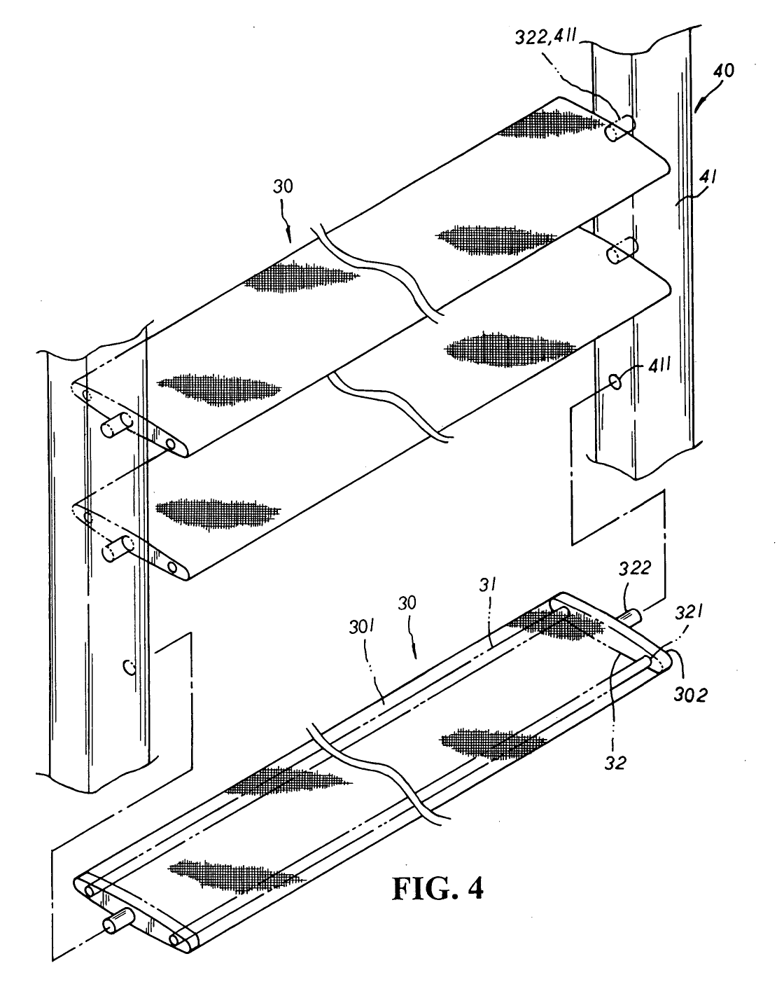

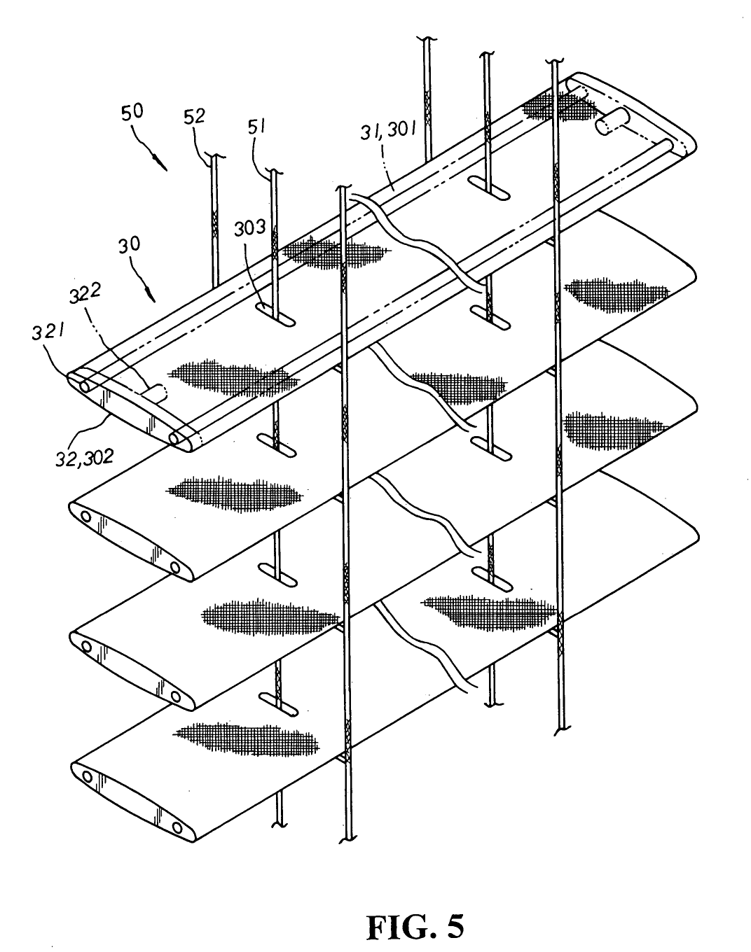

Please refer to FIG. 3. The present invention is related to a shutter blade structure, including a shutter 30 made of silk fabric that is integrally made into a transparent, semi-transparent, or opaque hollow shape with solid, colored, or patterned decoration designs disposed at the surface thereon. An oval-shaped hollow sleeve chamber 301 is disposed at the interior of the shutter 30 for two support rods 31 to be oppositely located therein, and a support opening 302 is respectively formed at both ends of the shutter 30 thereof for a retaining cap 32 to be registered therewith. The retaining cap 32 is identically shaped in conformance to the support opening 302 thereof with an outer periphery slightly larger than the support opening 302 so as to neatly expand the full width of the hollow sleeve chamber 301 in three-dimensional configuration thereby. The retaining cap 32 is provided with a pair of positioning holes 321 oppositely disposed at one side thereon for holding in place both ends of the two support rods 31 respectively, precisely supporting and stretching out the full length of the shutter 30 thereby. The retaining cap 32 is also equipped with a coupling section 322 properly protruding at the other side thereon to be mutually engaged with a pivoting groove 411 disposed at a left/right side frame 41 of a ventilation window 40 as shown in FIG. 4. Otherwise, the retaining cap 32 can also be reversed in the opposite direction to be mutually engaged with the support opening 302 thereof with the coupling section 322 reversibly located at the hollow sleeve chamber 301 therein, and cord-passage holes 303 are symmetrically disposed at preset positions of the shutter 30 thereon for pull cords 51 and ladder ropes 52 to be led there-through to provide a shutter 30 for a Venetian blind 50 as shown in FIG. 5. Thus, the shutter 30 is flexibly fit to both the ventilation window 40 and the Venetian blind 50, and is capable of being easily produced on a massive scale, efficiently simplifying the steps of processing so as to reduce the cost of production for achieving the economical efficiency and boosting the competitive power thereof on the market.

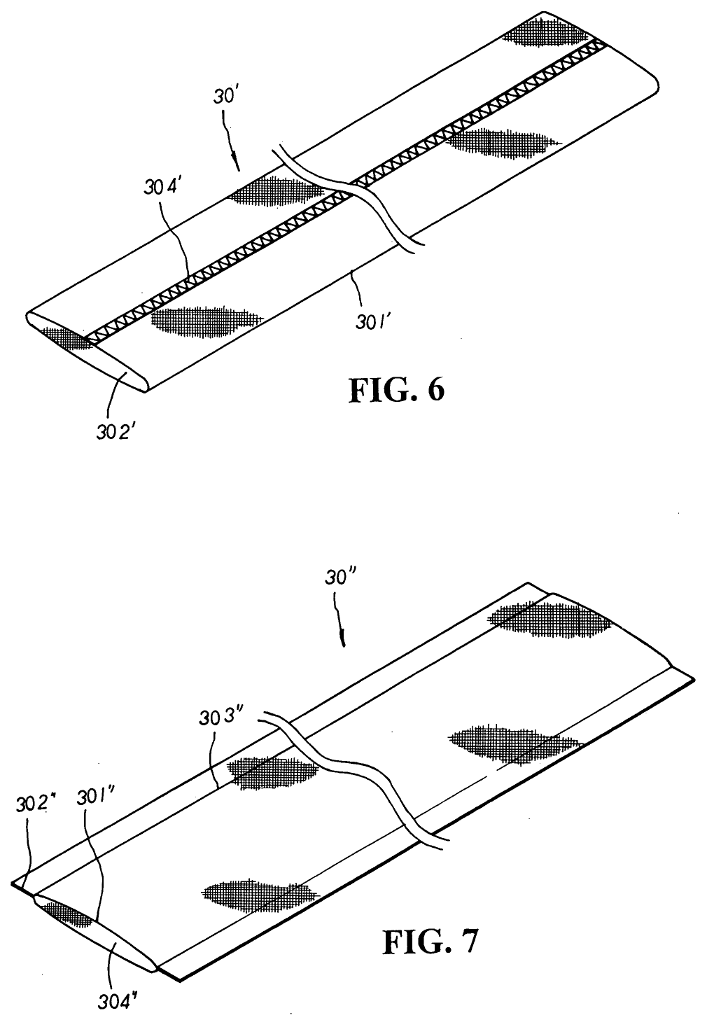

Please refer to FIG. 6. The present invention can also include a shutter 30′ made of a normal fabric or fiber fabric that is sewed together at both adjacent edges thereof to define a hollow sleeve chamber 301′ at the interior thereof for the two support rods 31 to be oppositely located therein, and to provide a seaming line 304′ disposed at the upper surface thereon. A support opening 302′ is formed at each end of the shutter 30′ to be mutually registered with the retaining cap 32 thereby. Thus, via the support rods 31 and the retaining caps 32 thereof, the shutter 30′ is neatly expanded in full width and length for assembly onto the ventilation window 40 as well as the Venetian blind 50 thereof

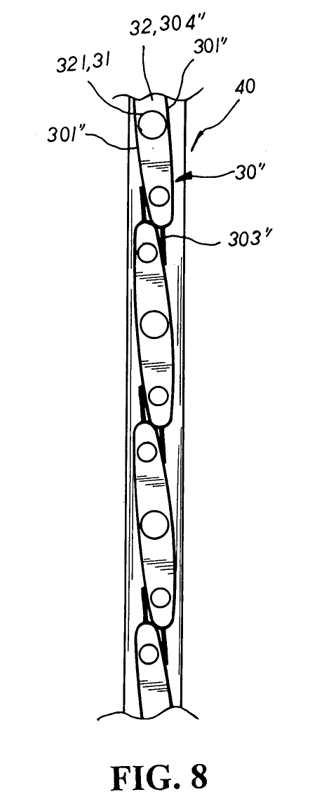

Please refer to FIGS. 7 to 8 inclusive. The present invention can also include a shutter 30″ made up of a two-piece fiber fabric wherein each piece of the fiber fabric has a semi-oval and protruding arch facet 301″ curving at the middle section thereof and an engaging section 302″ respectively extending at both long lateral edges of the protruding arch facet 301″ thereon. The engaging sections 302″ of the two-piece fiber fabric are securely combined together via thermal-welding operation or adhesive fastening agent to form a hollow sleeve chamber 303″ at the middle section thereof for the two support rods 31 to be oppositely located therein, and a support opening 304″ is formed at each end of the shutter 30″ to be mutually registered with the retaining cap 32 thereby. Thus, when the shutters 30″ are rotated upwards to a complete sheltering position, the engaging sections 302″ of each shutter 30″ are precisely piled up to abut against the protruding arch facets 301″ of the immediate upper and lower adjacent shutters 30″ as shown in FIG. 8, facilitating a better light sheltering and privacy protection effects thereof.

1. A shutter blade structure, including a shutter having a hollow sleeve chamber disposed at the interior therein for two support rods to be oppositely located therein, and a support opening respectively formed at both ends thereof for a retaining cap to be registered therewith wherein the retaining cap can neatly expand the full width of the hollow sleeve chamber and is provided with a pair of positioning holes symmetrically disposed at one side thereon for holding in place both ends of the two support rods respectively, precisely stretching out the full length of the shutter thereby; besides, the retaining cap is also equipped with a coupling section properly protruding at the other side thereon to be mutually engaged with a pivoting groove disposed at a left/right side frame of a ventilation window; otherwise, the retaining cap can also be reversed in the opposite direction to be mutually engaged with the support opening thereof with the coupling section reversibly located at the hollow sleeve chamber therein, and cord-passage holes can also be symmetrically disposed at preset positions of the shutter thereon for pull cords and ladder ropes to be led there-through to provide a shutter for a Venetian blind; thus, the shutter is flexibly fit to both ventilation windows and Venetian blinds, and is capable of being easily produced on a massive scale, efficiently simplifying the steps of processing so as to reduce the cost of production for achieving the economical efficiency and boosting the competitive power thereof on the market.

2. The shutter blade structure as claimed in claim 1 wherein the shutter thereof is integrally made of a silk fabric.

3. The shutter blade structure as claimed in claim 1 wherein the shutter thereof can be made into a transparent, semi-transparent, or opaque hollow shape with solid, colored, or patterned decoration designs disposed at the surface thereon.

4. The shutter blade structure as claimed in claim 1 wherein the hollow sleeve chamber of the shutter thereof is made in an oval shape.

5. The shutter blade structure as claimed in claim 1 wherein the retaining cap thereof is identically shaped in conformance to the support opening of the shutter with an outer periphery slightly larger than the support opening thereof.

6. The shutter blade structure as claimed in claim 1 wherein the shutter can also be made of a normal fabric or fiber fabric that is sewed together at both adjacent edges thereof to form a hollow sleeve chamber at the interior therein and a seaming line disposed at the upper surface thereon.

7. The shutter blade structure as claimed in claim 1 wherein the shutter thereof can also be made up of a two-piece fiber fabric each having a semi-oval and protruding arch facet curving at the middle section thereof respectively and engaging sections extending at both long lateral edges of the protruding arch facet thereon; the engaging sections of the two-piece fiber fabric thereof are securely combined together with a hollow sleeve chamber defined at the middle section therein and support openings formed at both ends thereof.
